(19) United States
(12) Patent Application Publication
(10) Pub. No.: US 2017/0109127 A1
(43) Pub. Date: Apr. 20, 2017

(54) TACTILATED ELECTRONIC MUSIC SYSTEMS FOR SOUND GENERATION

(71) Applicants: Owen Osborn, Philadelphia, PA (US); Christopher Kucinski, Brooklyn, NY (US)

(72) Inventors: Owen Osborn, Philadelphia, PA (US); Christopher Kucinski, Brooklyn, NY (US)

(21) Appl. No.: 15/275,469

(22) Filed: Sep. 25, 2016

Related U.S. Application Data
(60) Provisional application No. 62/232,649, filed on Sep. 25, 2015.

(51) Int. Cl. G06F 3/16; G06F 3/0482; G10H 1/00

(52) U.S. Cl. CPC G06F 3/165; G10H 1/0008; G06F 3/0482; G10H 2220/101; G10H 2210/125; G06F 3/02

(57) ABSTRACT

The present invention is directed to tactilated electronic music systems (TEMS) for sound generation. These novel electronic music systems are self-contained and computer-independent to afford full functional portability, and offer physical interfaces with wide variability in music creation and production. In particular embodiments, the TEMS of the present invention are expandable. Furthermore, particular embodiments of the present invention include the methods of producing music using a tactilated electronic music system (TEMS) of the present invention.

### RELATED APPLICATIONS

This application claims priority to U.S. Provisional Patent Application No. 62/232,649, filed on Sep. 25, 2015, under Attorney Docket No. CAG-006-1; the entirety of which is incorporated herein by reference.

### BACKGROUND OF THE INVENTION

In the world of music production, instruments and music systems can be classified into two major groups: portable and non-portable. Generally, analog music instruments that can be easily carried, offer the simplicity of portable music production but are limited in function. Electronic music systems, which offer greater functionality and customization, have been gaining popularity as compared to the standard analog instruments. However, the portability of electronic music systems has remained limited given the required tether to laptop or desktop computers for full functionality.

Furthermore, most portable electronic music systems (such as programmable pedals and related electronic devices) alter sound input, but still require a sound input source to generate music. Alternatively, portable applications and programs that operate on mobile devices are limited by the ability of the user to fully control the music expression as a result of the virtual nature of the control elements. Moreover, the lack of a physical control interface significantly limits variability in the nature of music creation, production and editing.

As such, there is a need for novel electronic music systems that are self-contained and computer-independent, affording full functional portability, and which offer physical interfaces with wide variability.

### SUMMARY OF THE INVENTION

Accordingly, the present invention is directed to tactilated electronic music systems (TEMS) for sound generation, as well as sound processing. These novel electronic music systems are self-contained and computer-independent to afford full functional portability, and offer physical interfaces with a wide range of variability in music creation and production. In particular embodiments, the TEMS of the present invention are expandable. Furthermore, particular embodiments of the present invention include the methods of producing music using a tactilated electronic music system (TEMS) of the present invention.

As such, one aspect of the invention provides a tactilated electronic music system (TEMS) for sound generation. The TEMS comprises an integrated CPU capable of efficiently managing an operating system and an advanced operational control structure, wherein the control structure is suitable to generate sound derived from dynamic patches; to convert digital audio bit stream to and from analog sound; to communicate data between the control elements and the other components of the control structure; and to operate an interactive selection menu interface. The TEMS also comprises a local display unit for locally displaying information within the system, and suitable for interfacing with the dynamic patches and the interactive selection menu; a selection actuator operationally associated with the local display unit for making selections in the interactive selection menu interface; and one or more control elements positioned for suitable access by a system operator designed to interface with the dynamic patches, wherein said control elements comprise at least one tactilated control element.

In another aspect, the present invention provides an expandable tactilated electronic music system (TEMS) for sound generation. The expandable TEMS comprises an integrated CPU capable of efficiently managing an operating system and an advanced operational control structure, wherein the control structure is suitable to generate sound derived from dynamic patches; to convert digital audio bit stream to and from analog sound; to communicate data between the control elements and the other components of the control structure; and to operate an interactive selection menu interface. The expandable TEMS also comprises a local display unit for locally displaying information within the system, and suitable for interfacing with the dynamic patches and the interactive selection menu; a selection actuator operationally associated with the local display unit for making selections in the interactive selection menu interface; one or more control elements positioned for suitable access by a system operator designed to interface with the dynamic patches, wherein said control elements comprise at least one tactilated control element. The expandable TEMS further comprises an expansion control linkage.

In yet another aspect, the present invention provides a method of producing music using a tactilated electronic music system (TEMS). The method comprises the steps of: obtaining a tactilated electronic music system (TEMS) of the present invention; and operating said TEMS, such that music is produced from the operation of the TEMS.

### BRIEF DESCRIPTION OF THE DRAWINGS

Advantages of the present apparatus will be apparent from the following detailed description, which description should be considered in combination with the accompanying drawings, which are not intended limit the scope of the invention in any way.

FIG. 1 depicts a front perspective view of a certain embodiment of an expandable tactilated electronic music system (TEMS) of the present invention.

FIG. 2 depicts a perspective view of a certain embodiment of an expansion control linkage of the expandable TEMS of the present invention, wherein both sides of the linkage are depicted.

FIG. 3 depicts a perspective view of a certain embodiment of an expansion module comprising an additional expansion control linkage to allow for duplication of the expansion connection in the same direction, which, in turn, allows the modules to be daisy chained together; wherein the expansion module comprises additional knobs.

FIG. 4 depicts a perspective view of a certain embodiment of an expandable TEMs of the present invention, shown with an expansion module of additional knobs connected to the TEMs.

FIG. 5 depicts a perspective view of a certain embodiment of an expandable TEMs of the present invention, shown with an expansion module of drum pads connected to the TEMs.

FIG. 6 depicts a perspective view of a certain embodiment of an expandable TEMs of the present invention, shown with two expansion modules of drum pads connected to the TEMs in sequence.

FIG. 7 depicts a perspective view of a certain embodiment of an expandable TEMs of FIG. 6, shown with a solar power expansion module connected.

FIG. 8 depicts a perspective view of a certain embodiment of an expandable TEMs of FIG. 7, shown with an expansion module speaker connected.

FIG. 9 depicts a perspective view of a certain embodiment of an expandable TEMs of the present invention, shown with a speaker expansion module connected to the TEMs.

FIG. 10 depicts a perspective view of a certain embodiment of an expandable TEMs of the present invention, shown with an expansion module of a microphone with gain control connected to the TEMs.

FIG. 11 depicts a perspective view of a certain embodiment of an expandable TEMs of the present invention, shown with an expansion module of a larger battery pack with solar panel connected to the TEMs.

FIG. 12 depicts a perspective view of a certain embodiment of an expandable TEMs of the present invention, shown with an expansion module of an acceleration sensor connected to the TEMs.

FIG. 13 depicts the general hardware components of one embodiment of the TEMS of the present invention, along with their interplay, in a flow chart diagram.

FIG. 14 depicts a flow chart of instructions stored on the hardware of one embodiment of the TEMS of the present invention.

FIG. 15 depicts a front perspective view of certain embodiments of the TEMs of the present invention, shown with several tactilated control elements.

FIG. 16 depicts a rear perspective view of the TEMs of FIG. 15, shown with several tactilated control elements, and depicting several ports and jacks.

### DETAILED DESCRIPTION OF THE INVENTION

The present invention is directed to tactilated electronic music systems (TEMS) for sound generation. These novel electronic music systems are self-contained and computer-independent to afford full functional portability in a music system, and offer physical interfaces with unlimited variability in music creation and production. In particular embodiments, the TEMS of the present invention are expandable. Furthermore, particular embodiments of the present invention include the methods of producing music using a tactilated electronic music system (TEMS) of the present invention.

The invention provides a user an environment that includes a tactile interface for generating and processing sound through dynamic patches.

The present invention, including tactilated electronic music systems and related methods will be described with reference to the following definitions that, for convenience, are set forth below. Unless otherwise specified, the below terms used herein are defined as follows:

### I. DEFINITIONS

As used herein, the term “a,” “an,” “the” and similar terms used in the context of the present invention (especially in the context of the claims) are to be construed to cover both the singular and plural unless otherwise indicated herein or clearly contradicted by the context.

The term “analog sound” is used herein to describe an electrical signal with a voltage level proportional to sound pressure level in air. This signal may be used to drive a speaker. In certain embodiments, this signal may be generated from a microphone or other pickup transducer (e.g., guitar pickup).

The term “audio hardware” is used herein to describe electronic circuitry capable of converting digital audio bit stream to and from analog sound (e.g., audio codec). This circuitry may be incorporated into a CPU or be comprised of one or more discrete integrated circuits. The circuitry also includes ports for connecting the analog sound to and from the device (sound input and sound output).

The language “control element” is used herein to describe the control interfaces that provide user input to the TEMS of the present invention (e.g., tactilated control elements) and/or output feedback from the TEMS to the user, as well as control interfaces that provide environmental input (e.g., sensors).

The term “digital audio bit stream (DABS)” is used herein to describe a signal within the general computational system that is a sequence of bits (0 or 1 value) that carries a digital representation of analog sound. The digital audio bit stream may contain one or more channels of analog sound.

The term “dynamic” as used herein, for example in the expression “dynamic patch,” describes the characteristic of a changeable nature. For example, a dynamic patch described herein is a patch that is capable of being modified; however, if capable of being modified, actual modification is not necessary to be considered dynamic.

The term “interface” is art-recognized, and is used herein to describe a shared boundary across which two separate components of a computer system exchange information, which can be between software, computer hardware, peripheral devices, humans and combinations of these.

Moreover, the operation of two separate components across the boundary, as in the interaction of the control elements which are designed to interface with the dynamic patches, is referred to herein as interfacing. In certain embodiments; the interfacing may be bi-directional. In other embodiments, the interfacing may be uni-directional.

The language “machine-readable medium” is art-recognized, and describes a medium capable of storing data in a format readable by a mechanical device (rather than by a human). Examples of machine-readable media include magnetic media such as magnetic disks, cards, tapes, and drums, punched cards and paper tapes, optical disks, barcodes, magnetic ink characters, and solid state devices such as flash-based, SSD, etc. Machine-readable medium of the present invention are non-transitory, and therefore do not include signals per se, i.e., are directed only to hardware storage medium. Common machine-readable technologies include magnetic recording, processing waveforms, and barcodes. In particular embodiments, the machine-readable device is a solid state device. Optical character recognition (OCR) can be used to enable machines to read information available to humans. Any information retrievable by any form of energy can be machine-readable. Moreover, any data stored on a machine-readable medium may be transferred by streaming over a network. In a particular embodiment, the machine readable medium is a network server disk, e.g., an internet server disk, e.g., a disk array.

The term “music” is used herein to describe the aggregation or combination of sounds in succession to produce temporal relationships between the sounds that afford a composition having unity and continuity, e.g., including one or more elements of rhythm, melody, and harmony.

The term “obtaining” is art recognized; and is used herein to describe the act or step of acquiring an item, e.g., by taking receipt or by purchase.

The term “operationally associated” is art-recognized, and is used herein to describe items that are associated, connected, or related in such a manner as to achieve a common intended purpose of operation of the items together. For example, a selection actuator may be operationally associated with the local display unit such that the two components are connected in such a way, e.g., through linking hardware or software, as to afford the ability of the selection actuator to directly interact with items displayed on the local display unit.

The language “operating system” is art-recognized, and describes the general system of low level computational routines that provide low level input/output functionality allowing the general computational system to communicate with the hardware, e.g., access to USB ports, audio hardware, or Wi-Fi network. In certain embodiments, the operating system is open source, e.g., Linux.

The term “patch” is art-recognized, and describes a file comprising one or more file subsets that can be recalled for interpretation and/or playback. A patch may consist of one or more patch files stored on the machine-readable medium, which define the mapping of the functions of one or more control elements as well as the sound processing and/or generation methods. Additionally a patch may consist of one or more files that may be used inside of the patch, e.g., sound samples for playback, or MIDI sequences for playback.

The term “sound” is used herein to describe a singular or individual tone or noise, e.g., which may be aggregated (e.g., in certain ways to produce music) by the TEMS of the present invention.

The term “sound input” is used herein to describe an electrical analog sound signal derived from an external device (e.g., electric guitar or microphone) and directed into the TEMS.

The term “sound output” is used herein to describe an electrical analog sound signal derived from the TEMS and directed into an external device, e.g., a speaker.

The term “sound generation” is used herein to describe the process of creation of sound using a process defined by a patch, and ultimate conversion of the digital audio bit stream through audio hardware to sound output, e.g., through a speaker. It should be understood that the digital audio bit stream may be stored for later sound output or further sound processing.

The term “sound processing” is used herein to describe the process of receiving a sound input (e.g., from a microphone or guitar), and ultimately converting the input using audio hardware into a digital audio bit stream, modifying the digital audio bit stream using a process defined by a patch, and ultimate conversion of the digital audio bit stream using audio hardware to sound output (e.g., through a speaker). It should be understood that either (or both) the digital audio bit stream may be stored for later sound output or further sound processing.

The term “tactile” is used herein to describe the characteristic of a referenced item being designed for use by interaction with the item via a sense of touch, i.e., touching a physical interface through physical interaction; as differentiated from the interaction offered through the sense of touch of a planar (i.e. two-dimensional) interface that occurs with virtual interfaces, e.g., virtual controls such as on a mobile phone or tablet interface. It is the advantage of the tactile characteristic, and non-discrete fluidity of the tactilated control elements of the present invention that afford a truer and greater control over the wide range of variability in music creation, production, and editing in ways that the discrete virtual control interfaces are not able achieve.

The term “tactilated” is used herein to describe the characteristic of making a component, e.g., a control element, regulated by tactile sensation, for example, through finger manipulation.

The language “tactilated control element” is used herein to describe control elements wherein the user input is regulated by tactile sensation of a physical control interface, for example, through finger manipulation (e.g., a tactilated, keys, knobs, rotary encoders, buttons, or pads).

The term “user” or “system operator” are used interchangeably herein to describe any person that interfaces with the TEMS of the present invention. Such user, in certain embodiments, interacts with the control elements described herein through tactile control of the control elements (e.g., keys, knobs, rotary encoders, buttons, or pads).

### II. TACTILATED ELECTRONIC MUSIC SYSTEM (TEMS)

In one embodiment, the present invention provides a tactilated electronic music system (TEMS) for sound generation comprising
an integrated CPU capable of efficiently managing an operating system and an advanced operational control structure, wherein the control structure is suitable to generate sound derived from dynamic patches; to convert digital audio bit stream to and from analog sound; to communicate data between the control elements and the other components of the control structure; and to operate an interactive selection menu interface;
a local display unit for locally displaying information within the system, and suitable for interfacing with the dynamic patches and the interactive selection menu;
a selection actuator operationally associated with the local display unit for making selections in the interactive selection menu interface; and
one or more control elements positioned for suitable access by a system operator designed to interface with the dynamic patches, wherein said control elements comprise at least one tactilated control element. In certain embodiments, the control structure is suitable to process and generate sound derived from dynamic patches.

The combination of hardware and instructions stored thereon for execution by the hardware, e.g., a processor, to perform one or more methods to achieve sound generation contributes to the novel tactilated electronic music systems of the present invention. The operating system on the CPU interfaces with the advanced operational control structure, which is the entire collection of instructions running on the TEMS that provides the functionality for the patch creation, running, editing, sharing, copying, and deletion. The advanced operational control structure, as described herein, is suitable to generate sound derived from dynamic patches (e.g., as well as to process the sound); to convert digital audio bit stream to and from analog sound; to communicate data between the control elements and the other components of the control structure; and to operate an interactive selection menu interface.

A. Hardware Components of the TEMS

The hardware components of the tactilated electronic music systems of the present invention include, but are not limited to circuit boards (e.g., microprocessors, audio circuitry, power regulation, etc.), one or more machine readable media, one or more display units, one or more selection actuators, and one or more control elements.

### Central Processing Unit (CPU

At least one circuit board of the TEMS of the present invention is an integrated CPU capable of efficiently managing an operating system and an advanced operational control structure. In certain embodiments, the CPU is characterized by processing speeds of greater than 500 MHz, e.g., greater than or equal to 1 GHz. In certain embodiments, the CPU is capable of efficiently managing the input and output received from one or more of the data transfer methods selected from the group consisting of HDMI, USB, Wi-Fi, Bluetooth and MIDI.

In certain embodiments, the CPU is connected to other hardware components, e.g., a microprocessor, over a serial connection (e.g. wherein the CPU is a significantly more powerful microprocessor). The CPU is responsible for directly connecting to the USB, HDMI video, Wi-Fi and MIDI ports and adapters. Moreover, in certain embodiments, the CPU also connects to an audio codec, e.g., a separate IC that converts a digital audio bit stream to and from analog sound.

### Local Display Unit

The TEMS of the present invention comprises a local display unit for locally displaying information within the system, and suitable for interfacing with the dynamic patches and the interactive selection menu (e.g., the dynamic patches are located on one or more machine readable medium). In certain embodiments, the local display unit is touch sensitive, e.g., the local display unit may comprise touch screen control.

### Selection Actuator

The TEMS of the present invention comprises a selection actuator operationally associated with the local display unit for making, or actuating, selections in the interactive selection menu interface. In a particular embodiment, the selection actuator is incorporated into the local display unit.

### Control Elements

The TEMS of the present invention comprises one or more control elements positioned for suitable access by a system operator designed to interface with the dynamic patches, wherein said control elements comprise at least one tactilated control element. In certain embodiments, the TEMS comprises one tactilated control element. In certain embodiments, the TEMS comprises two tactilated control elements. In certain embodiments, the TEMS comprises three tactilated control elements. In certain embodiments, the TEMS comprises four tactilated control elements. In certain embodiments, the TEMS comprises five tactilated control elements. In certain embodiments, the TEMS comprises greater than five tactilated control elements. In certain embodiments, the TEMS comprises greater than 10 tactilated control elements. In certain embodiments, the TEMS comprises greater than 20 tactilated control elements. In certain embodiments, the TEMS comprises greater than 30 tactilated control elements.

In certain embodiments, the control elements provide input to the TEMS. For example, such control elements may be selected from one or more of the following: keys, knobs, rotary encoders, buttons, pads, control voltage, accelerometer, GPS, light sensor, temperature, drum pads, faders (linear potentiometers), joystick, slider (e.g., touch sensitive linear position sensor), capacitive touch sensor, switch, photoelectric sensor, infrared proximity sensor, ultrasonic proximity sensor, microphone, gyroscope, galvanometer, piezo sensor, radar, altimeter, flow sensor (e.g., air or water), radio (e.g., FM, AM, Ham, or CB), magnetometer, magnetic field sensor, Hall effect sensor, anemometer, Geiger counter, barometer, inclinometer, tilt sensor, photodiode, fingerprint, flex, gesture (e.g., swiping over the device), gas (e.g., CO₂ or oxygen), brain waves, IMU, breathalyzer, pressure sensor, strain gauge, reed switch, or camera.

In certain embodiments, the control elements provide output to the user from the TEMS. For example, such control elements may be selected from one or more of the following: LED, LED matrix, bar graph LED, vibration motor, audio feedback (e.g., bell or chime), number display (e.g., LED), graph, screen, or control voltage.

In certain embodiments of the present invention, the tactilated control elements comprise elements selected from the group consisting of keys, knobs, rotary encoders, buttons, and pads. In certain embodiments the tactilated control elements are force sensitive.

In certain embodiments of the present invention, the control elements are in a keyboard orientation, i.e., an orientation of keys on the TEMS that is generally familiar to the user based on similarity to a piano (i.e., a piano keyboard). In particular embodiments, the control elements in the keyboard orientation are tactilated control elements.

In certain embodiments of the present invention, the TEMS further comprises one or more indicator lights, e.g., an LED indicator.

In certain embodiments of the present invention, the TEMS further comprises an Aux button, e.g., a button not consistent with any keyboard orientation.

In certain embodiments of the present invention, the TEMS further comprises one or more of the following: an accelerometer, a GPS, a gyroscope, and/or light sensors for controlling parameters in certain modes.

In certain embodiments of the present invention, the TEMS further comprises control voltage inputs/outputs for connecting to other devices that use control voltage.

### Audio Codec

In certain embodiments of the present invention, the TEMS further comprises an audio codec operationally associated with the CPU that converts digital audio bit stream to and from analog sound. In certain embodiments, the audio codec is capable of efficiently managing the sound input, e.g., microphone, and the sound output, e.g., speaker. In certain embodiments, the audio codec is a separate integrated circuit (IC).

### Machine-Readable Medium

In certain embodiments of the present invention, the TEMS further comprises one or more machine-readable medium. The machine-readable medium may have one or more sets of instructions stored thereon. In certain embodiments the machine-readable medium is selected from the group consisting of magnetic media, optical disks, and solid state devices. In a particular embodiment, the machine-readable medium is a solid state device.

In certain embodiments of the present invention, the TEMS further comprises a first machine-readable medium having instructions stored thereon for execution by a processor to perform a method comprising the step of: interfacing with the control elements.

In certain embodiments of the present invention, the TEMS further comprises a first machine-readable medium having instructions stored thereon for execution by a processor to perform a method comprising the steps of: scanning the control elements, reading the positions of each control element, displaying pixels on the local display unit, and communicating with the CPU, such that the machine-readable medium is capable of communicating data between the control elements and the other components of the control structure. In certain embodiments, the first machine-readable medium is a microcontroller operationally associated with the CPU. The screen-based user interface on the local display unit assists in managing the state of the TEMS: starting patches, starting the patch editor, and other system functions (e.g., turning off the machine, or configuring Wi-Fi).

In certain embodiments of the present invention, the TEMS further comprises a second machine-readable medium having instructions stored thereon for execution by a processor to perform a method comprising the steps of: interpreting patch files; generating a digital audio bit stream; directing the digital audio bit stream to and from the audio hardware (e.g., audio codec IC); and providing a graphical user interface for creating, editing, copying, sharing, and deleting patch files.

In certain embodiments of the present invention, the TEMS further comprises a third machine-readable medium having instructions stored thereon for execution by a processor to perform a method comprising the steps of: communicating with the first machine-readable medium, sending and receiving data to and from the control elements, packaging data suitable for display (e.g., on a local display unit or an external monitor data to a screen), providing the interactive selection menu interface capable of responding to user input from the selection actuator, and communicating values from control elements into the second machine-readable medium. In certain embodiments, the third machine-readable medium is capable of interfacing with the operating system, e.g., wherein the third machine-readable medium is an interface for passing data between the control elements and the other components of the control structure. In a particular embodiment, the interface controller is responsible for exchanging data between control elements and the patch interpreter and patch editor where they are utilized in a patch.

In certain embodiments of the present invention, the second machine-readable medium and the third machine-readable medium are the same machine-readable medium.

In certain embodiments of the present invention, the first machine-readable medium, second machine-readable medium and the third machine-readable medium are the same machine-readable medium.

In certain embodiments of the present invention, the second machine-readable medium and the third machine-readable medium are onboard the CPU.

### Additional Features

In certain embodiments of the present invention, the TEMS further comprises one or more ports selected from the group consisting of HMDI, USB, memory card, and MIDI. For example, an HDMI port may be used to connect a monitor, and a USB port may be used to connect a computer keyboard and mouse. However, in a particular embodiment, the local display unit is designed to be large enough that connection to a monitor is unnecessary.

In certain embodiments of the present invention, the TEMS further comprises one or more adapters selected from the group consisting of Wi-Fi and Bluetooth.

In certain embodiments of the present invention, the TEMS further comprises one or more jacks selected from the group consisting of a sound output jack, a sound input jack, and a headphone jack.

In certain embodiments of the present invention, the TEMS further comprises a speaker unit.

In certain embodiments of the present invention, the TEMS further comprises a power source to power the operations of the TEMS, e.g., a power jack to receive power or a battery. In certain embodiments of the present invention, the TEMS further comprises a battery. In certain embodiments, the battery is housed in a battery compartment. In particular embodiments, the battery is removable.

In certain embodiments of the present invention, the TEMS further comprises an enclosure, i.e., an external case enclosing the components of the TEMS. In particular embodiments, the external case may comprise one or more of the following components: aluminum, wood, ABS plastic, metal screws, and rubber feet.

In certain embodiments, the control elements, ports, and jacks are positioned in the TEMS enclosure for suitable access by an operator.

In certain embodiments of the present invention, the TEMS further comprises additional control elements for expanded control.

In certain embodiments of the present invention, the TEMS further comprises basic, intermediate and/or advanced functionalities mentioned above, but for video generation and/or processing. In this manner, video generating and/or processing functionality may be added to supplement or replace the audio generating and/or processing functionality. In particular embodiments, the TEMS may comprise hardware changes related to the video generation and/or processing, for example, adding video input(s).

B. Instructions Stored on the Hardware of the TEMS

A tactilated electronic music system (TEMS) for sound generation of the present invention comprises instructions stored on the hardware of the TEMS. The instructions serve to provide a user with the ability to execute certain methods, including the advanced operational control structure, which is the entire collection of instructions running on the TEMS that provides the functionality for the patch creation, running, editing, and deletion. The advanced operational control structure, as described herein, is suitable to process and generate sound derived from dynamic patches; to convert digital audio bit stream to and from analog sound; to communicate data between the control elements and the other components of the control structure; and to operate an interactive selection menu interface.

In the present invention, at the most general level, the TEMS is capable of efficiently managing both an operating system and an advanced operational control structure.

### Operating System

The operating system is responsible for interacting with the low level hardware: USB, HDMI video, Wi-Fi, MIDI and audio. Moreover, it comprises the general system of low level computational routines that provide low level input/output functionality allowing the general computational system to communicate with the hardware, e.g., access to USB ports, audio hardware, or Wi-Fi network. In certain embodiments, the operating system is open source, e.g., Linux. The CPU of the TEMS is designed to efficiently managing both an operating system and an advanced operational control structure, simultaneously.

### Advanced Operational Control Structure

The advanced operational control structure is the entire collection of instructions stored on the hardware needed to make the device functional, e.g., beyond the operating system. The advanced operational control structure provides an interface controller, patch interpreter/editor, and an interactive selection menu interface.

1. Interface Controller

The advanced operational control structure is suitable to communicate data between the control elements and the other components of the control structure. It is responsible for reading the state of input control elements (e.g., keys or knobs), and setting the state of output control elements (e.g., indicator LED). It opens communication channels so that the other components of the control structure (e.g., patch interpreter or patch editor) can interface with the control elements. In certain embodiments, the instructions for this operation, may be stored on a first machine-readable medium comprising a processor, e.g., a microcontroller, and is designed to scan the keys, read the position of the knobs and selection actuator, and display pixels on the small screen, as well as handle communication with the CPU.

In certain embodiments, the interface controller also communicates with expansion bus and provides communication so that the other components of the control structure can interface with the control elements on the expansion bus.

In particular embodiments, the instructions may be in form of a firmware-type program.

2. Patch Interpreter and Patch Editor

The advanced operational control structure interprets patch files; generates a digital audio bit stream; directs the digital audio bit stream to and from the audio hardware; and provides a graphical user interface for creating, editing, copying, sharing and deleting patch files. The steps are controlled through bi-level operation using a patch interpreter and patch editor.

The patch interpreter is responsible for patch running. It runs in the background (i.e., it has no user interface), and it is started and stopped from the interactive selection menu interface.

The patch editor allows for patch creating, editing, copying, sharing and deleting, wherein a screen based user interface is provided in the interactive selection menu interface.

In certain embodiments, the patch editor is offered so that the user may take advantage of a visual programming language (e.g., a graphical patching program), wherein the program enables musicians, visual artists, performers, researchers, and developers to create software graphically, without writing lines of code that is used to process and generate sound, video, 2D/3D graphics, interface sensors, input devices, and MIDI. In certain embodiments, the patching program is a graphical patching program, e.g., PureData™ (i.e., an open source graphical music creation software).

The patch editor offers unique and dynamic control to the user on the TEMS of the present invention, without the need for a separate computer, and therefore is not tethered in the fashion of other programmable music devices.

Patches are stored on memory media, i.e., a machine-readable medium. The patch interpreter accesses this storage medium to load patch files to run them. The patch editor accesses this storage medium to edit patch files. The storage medium may be located internally, externally via USB or memory card, or online server over Wi-Fi.

Together the patch interpreter and patch editor allow the following operations:

Patch Running (Playing)

In order for the patch to generate and or process sound (run), the patch files must be loaded into the patch interpreter. The interactive selection menu interface provides the mechanism for a user to select a patch to run. Moreover, while a patch is in the editor mode, the TEMS is able to run it.

Patch Editing

The program allows patches to be edited in real time (i.e. while the patch is being run). This means the patch files are loaded in to the patch interpreter while being simultaneously edited by the patch editor so that changes made to the patch files are experienced immediately. The patch editor affords configuration control over the sound process used to generate or process sound. Additionally the patch editor, affords dynamic configuration control of the functionality of control elements through control element mapping. The ability to adjust these configurations (e.g. how the sound is created and how the control elements are mapped to adjust the sound) enables the creation of new musical behaviors (see example patches). The fact that a patch may be edited as it is being run contributes to the advanced nature of the TEMS of the present invention.

Patch Creating

The patch editor program also allows patches to be created from scratch. Once a new patch is created, the patch editor allows control mapping and a sound process to be setup and edited as needed.

Patch Copying

An entire patch may be copied within the patch editor and the copy can be edited independently of the original. Additionally, ‘hybrid’ patches can be created by copying a part or parts from one patch into another patch. Multiple patches can contribute parts to a hybrid patch.

Patch Sharing

When the device is connected to Wi-Fi, patches may be shared with other users as they are being editing, e.g., by uploading to a network server. In certain embodiments, this function is provided by the patch editor. Other users may then load the patch and use it or continue editing it. As such, the TEMS of the present invention provides unique ability to collaborate, where the instrument is being extended and improved by users in different locations.

Patch Deleting

Patches may also be deleted with the patch editor.

3. Interactive Selection Menu Interface

The advanced operational control structure is suitable to operate an interactive selection menu interface. Patches are stored on a memory medium, i.e., machine-readable medium. The interactive selection menu interface accesses this storage medium to list available patches. In certain embodiments, dynamic patch selection may made from a list of patches stored on an internal or externally derived machine-readable medium (e.g., a USB drive), which displays in the interactive selection menu interface on the local display unit. Furthermore, additional system level functions, e.g., shutting down the device or reloading a USB drive, may be provided through the interactive selection menu interface. For example, in certain embodiments, the interactive selection menu interface functions in the following manner:
1. Draws an interactive menu on the screen and responds to user input from the selection actuator;
2. Loads a list of patches from a machine-readable medium, e.g., USB drive, and lists them in the menu;
3. Loads the selected patch into a patching program when selected; and
4. Provides some system level functions, e.g., shutting down the device, or reloading a USB drive.

Such interface is designed to operationally associate the selection actuator with the local display unit for making selections, e.g., dynamic patch selection (which is in turn accompanied by control element mapping). The selection actuator may be used to view and select a patch, which action is displayed on the local display unit through this interface.

C. Dynamic Patches

The TEMS of the present invention are capable of generating and processing sound derived from dynamic patches. A patch consists of one or more files. Each patch has a folder on the patch storage medium where these files are stored. The files may be text files, sound files (e.g., drum samples), MIDI files (e.g., sequences), and/or any other file needed by the patch. Generally speaking, the patch defines a sound process and a control element mapping:

Sound Process

The sound process is the part of a patch that defines how sound gets created or effected. There are many different kinds of processes that may be utilized and combined inside a patch. Examples include synthesizing sound, playing back sound samples, recording samples, effecting sounds or audio input, or any combination of these.

Control Element Mapping

Control element mapping defines how control elements are connected to the sound process. For example, a key press might be used to change the frequency on a synthesizer process, or turning a knob might change the loop time on a delay effect process.

In particular embodiments, exemplary sound processes include, but are not limited to the following, which are patch examples based on a particular embodiment of the TEMS that comprises the following control elements: force-sensitive keys in a piano keyboard orientation, one force-sensitive auxiliary button, and four rotary knobs:

Synthesizer:
Keyboard is mapped to a sound generation process so that pressing on a key causes that sound to be generated respective of pitch determined by the key. The control knobs are mapped to control parameters of the sound generation process such as delay time or vibrato rate.

Drum machine:
Individual keys of the keyboard are mapped to play drum samples when pressed. The force-sensing keyboard is mapped to control volume of playback or playback speed. Sequences may be recorded using the ‘Aux’ button to control record start, record stop and playback start. The control knobs are mapped to control parameters such as drum sample playback length or sequence playback rate.

Sound Recorder:
The Aux button is mapped to a process for recording sound from the audio input jacks. Pressing the Aux button once starts recording, pressing it again stops the recording. The recording is saved as a sound file to the USB drive.

Sound Player:
Individual keys of the keyboard are mapped to play sound files that are stored as sound files (e.g., in a folder on the USB drive). The force-sensing keyboard is mapped to control volume of playback or playback speed. Sequences are recorded using the ‘Aux’ button to control record start, record stop and playback start. The control knobs are mapped to control parameters such as sample playback length or sequence playback rate.

MIDI sequencer:
Similar to the sound player, but what is being played back are MIDI files (e.g., stored on USB drive). Individual keys are mapped to different MIDI files. The control knobs are mapped to control parameters such as playback rate, instrumentation selection, amount of swing, etc.

Looper:
Similar functionality as the Sound Player, but after the sound file is created, it begins playback. When the end of the file is reached, it begins playing back from the beginning. The knobs are mapped to playback speed and loop length in order to manipulate playback.

Sampler:
The Aux button is mapped to a process that records sound. As long as the key is held down, sound is recorded from the audio input. The keyboard is mapped to trigger playback of the recorded sound such that each key plays back the sound at a different speed. The knobs are mapped to control other elements of playback, such as loop length.

Effect Processor:
The knobs are mapped to control process that affects sound input which is then passed to the sound output. Examples of effects are distortion, tremolo, chorus, flanger, phaser, etc.

### III. EXPANDABLE TACTILATED ELECTRONIC MUSIC SYSTEM (TEMS)

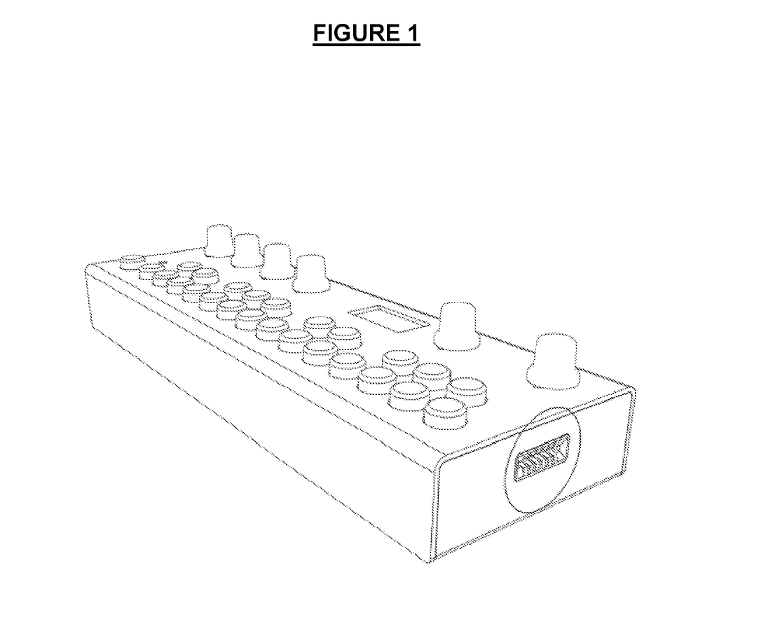

In certain embodiments of the present invention, the TEMS further comprises an expansion control linkage. In certain embodiments, the expansion control linkage combines power, sound input/output (e.g., from an audio codec), and serial data input/output into one connector located at the side of the device (FIG. 1). In certain embodiments of the present invention, the expansion control linkage is an edge card style connector. In an alternative embodiment, the expansion control linkage is a magnetic connection system.

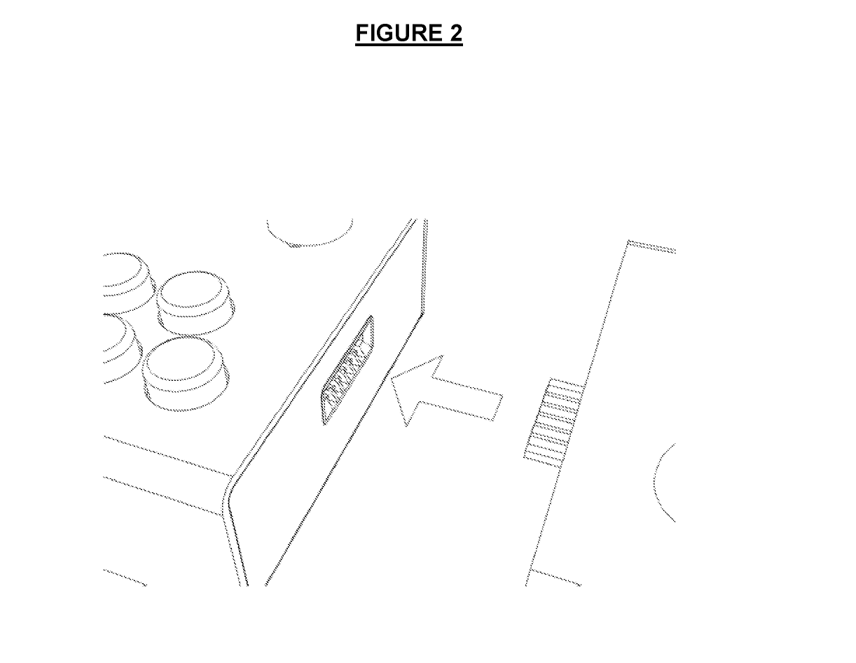

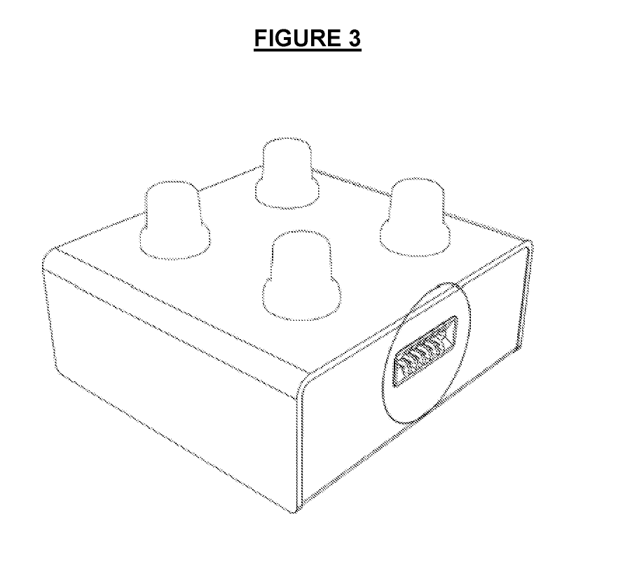

In certain embodiments of the present invention, the expandable TEMS comprises one or more expansion modules that add functionality to the TEMS (FIG. 2). In certain embodiments of the present invention, the expansion module comprises an expansion control linkage for serially linking with another expansion module (e.g., male/female couplings). This characteristic of the expansion modules allows for duplication of the expansion connection in the same direction, which, in turn, allows the modules to be daisy chained together (FIG. 3). This scheme allows multiple expansion modules of the same or different types to be connected through the expansion control linkage.

In certain embodiments, the expansion control linkage allows a variety of add-on modules to be hot-plugged into the TEMS (or an expanded TEMS).

Accordingly, another embodiment of the present invention provides an expandable tactilated electronic music system (TEMS) for sound generation comprising
an integrated CPU capable of efficiently managing an operating system and an advanced operational control structure, wherein the control structure is suitable to generate sound derived from dynamic patches; to convert digital audio bit stream to and from analog sound; to communicate data between the control elements and the other components of the control structure; and to operate an interactive selection menu interface;
a local display unit (e.g., touch sensitive) for locally displaying information within the system, and suitable for interfacing with the dynamic patches and the interactive selection menu (e.g., the dynamic patches are located on one or more machine readable medium);
a selection actuator operationally associated with the local display unit for making selections in the interactive selection menu interface (e.g., wherein the selection actuator is incorporated into the local display unit);
one or more control elements positioned for suitable access by a system operator designed to interface with the dynamic patches, wherein said control elements comprise at least one tactilated control element; and
an expansion control linkage.

In certain embodiments of the invention, the expandable TEMS comprise one or more expansion modules that add functionality to the TEMS. In particular embodiments, the expansion modules are selected from the group consisting of a speaker, a control element (e.g., a tactilated control element, e.g., keys, knobs, rotary encoders, buttons, or pads), a battery, a charge collector (e.g., solar panel based or acceleration based), an accelerometer, a port, an adapter, microphone (e.g., with gain control), and a combination thereof.

Given that the expansion control linkage also carries serial data into and out of the device, additional tactilated control elements may be added to the TEMS, for example, drum pads or more knobs. Moreover, the data from these interface modules becomes available in the patch editor just like the knobs and the keys on the main device. In this way, a user can create and use patches that take advantage of the additional control elements in real-time.

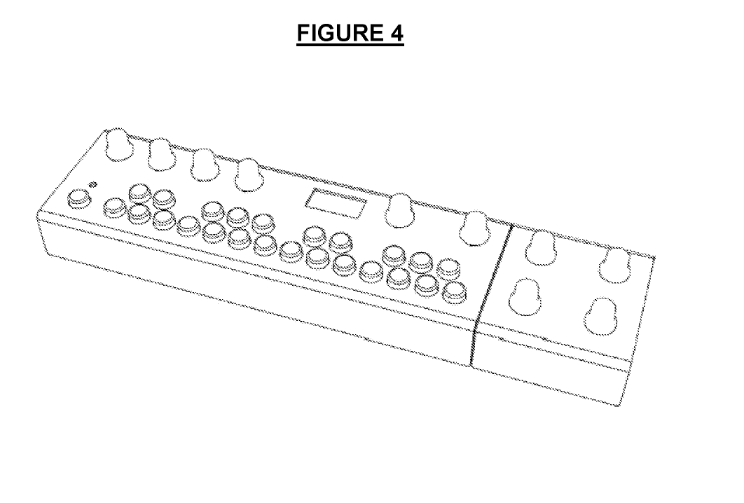

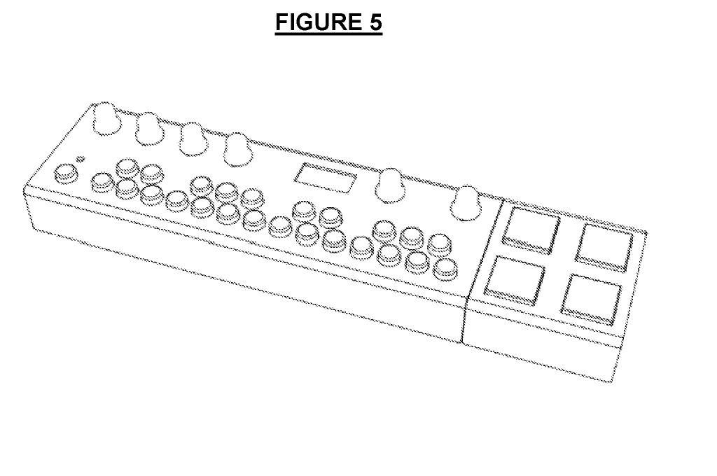

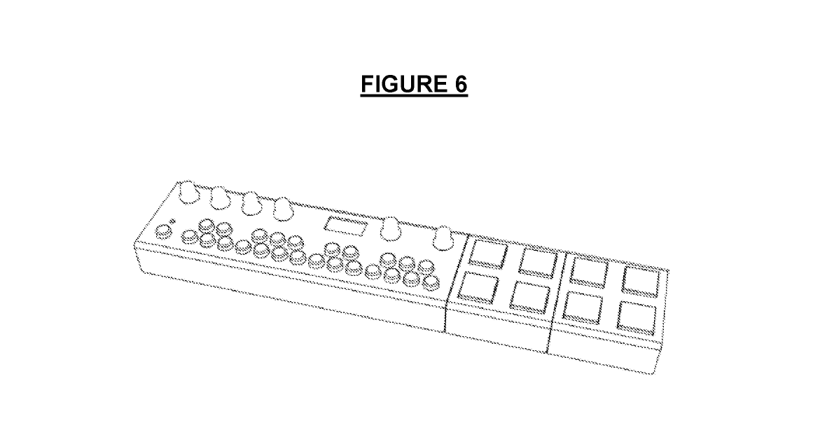

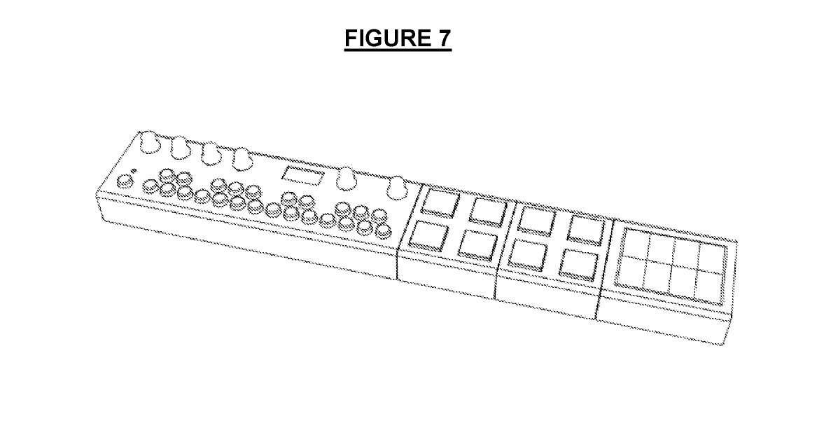

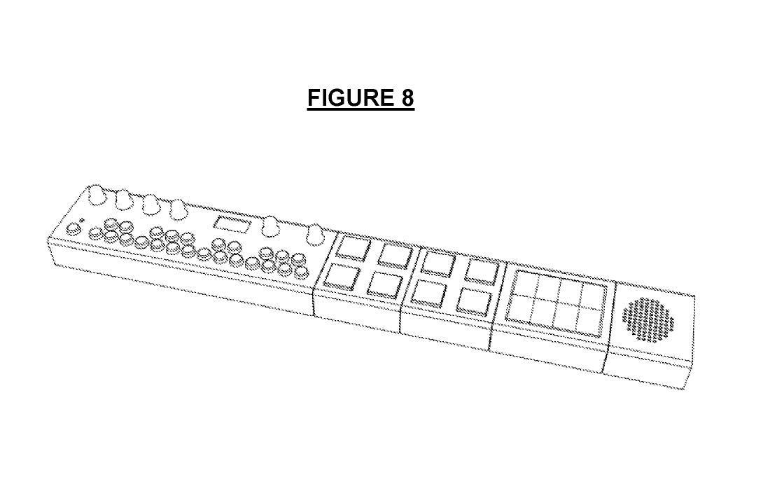

Certain exemplary embodiments of the expansion modules that are linkable to the core TEMS through the expansion control linkage include: additional knobs (FIG. 4); drum pads (FIG. 5); multiple drum pads (FIG. 6); addition of solar power expansion module (FIG. 7); and further addition of a speaker (FIG. 8).

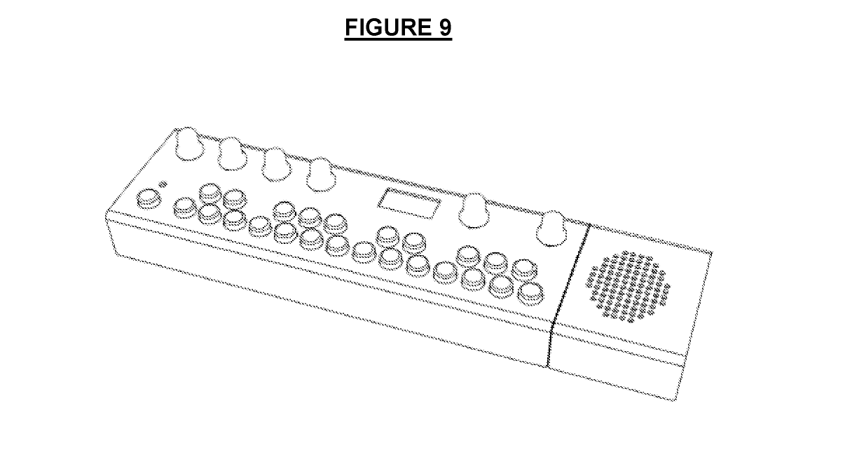

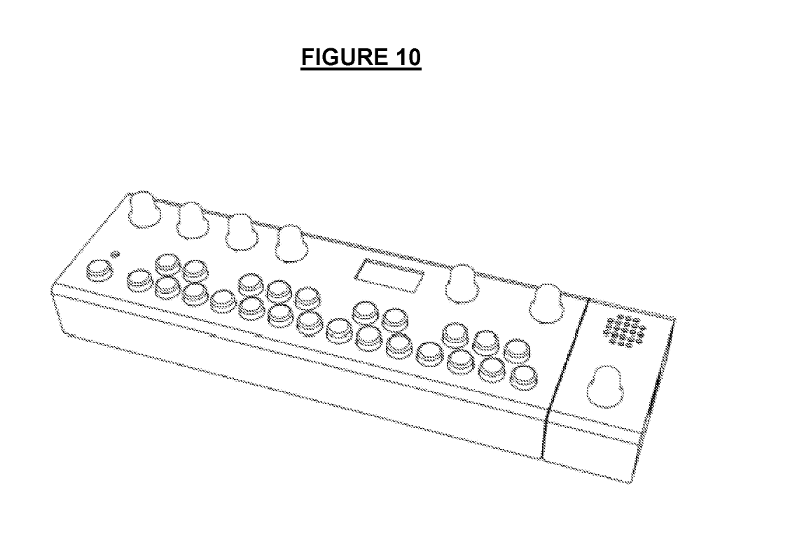

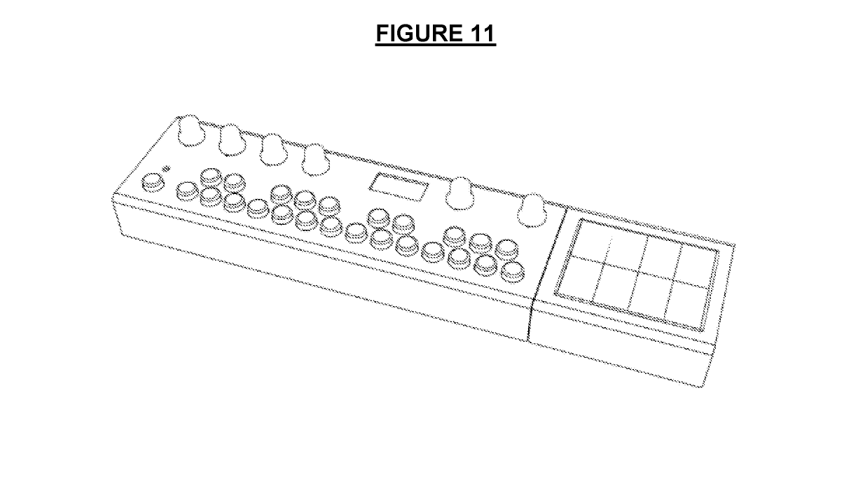

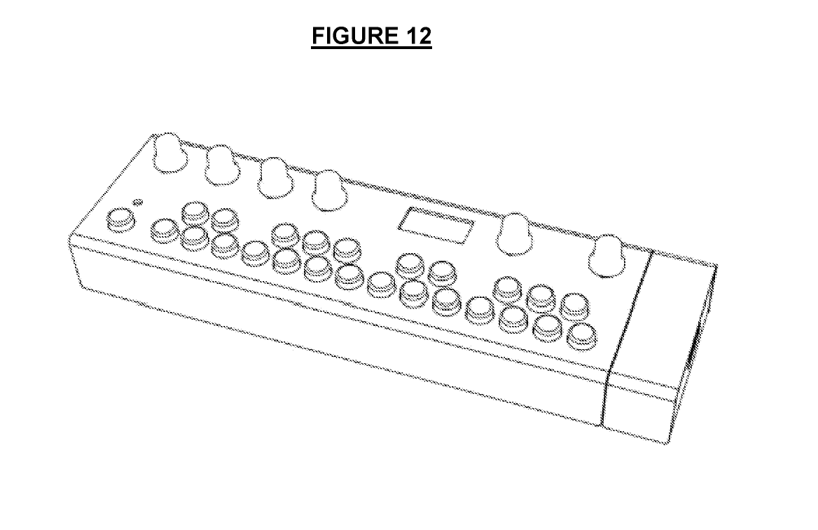

Certain additional exemplary embodiments of the TEMS with one single expansion module that is linkable to the core TEMS through the expansion control linkage include a speaker (FIG. 9); a microphone with gain control (FIG. 10); a larger battery pack with solar panel (FIG. 11); or an acceleration (FIG. 12) or any other kind of sensor.

### IV. METHODS OF MUSIC PRODUCTION OF USING THE TEMS OF THE INVENTION

Another embodiment of the present invention provides a method of producing music using a tactilated electronic music system (TEMS) comprising the steps of:
obtaining a tactilated electronic music system (TEMS) of any one of the TEMS of the present invention; and
operating said TEMS,
   such that music is produced from the operation of the TEMS.

### V. DESIGN ASPECTS OF THE INVENTION

The ornamental appearance of any novel design provided herein is intended to be part of this invention, for example, the external appearance of the music systems of the present invention, e.g., as shown in the figures presented herein, which may form an independent or combined ornamental appearance of the TEMS or expandable TEMS described herein.

Accordingly, one embodiment of the present invention provide an ornamental design for an electronic music system as shown and described.

### EXEMPLIFICATION

Having thus described the invention in general terms, reference will now be made to the accompanying drawings of exemplary embodiments, which are not necessarily drawn to scale, and which are not intended to be limiting in any way.

In this respect, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### Example 1

### General Hardware

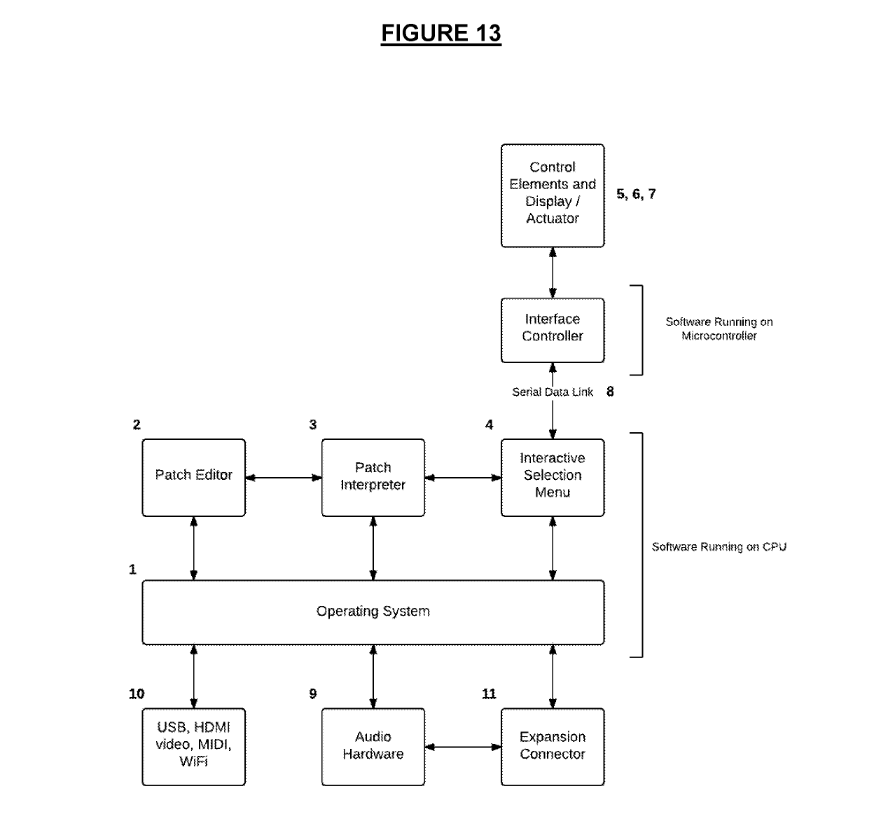

The general hardware components of one embodiment of the TEMS of the present invention, along with their interplay, are depicted in the general hardware flow chart of FIG. 13.

Operating System 1 is managed by an integrated CPU, which also manages an advanced operational control structure comprising Patch Editor 2, Patch Interpreter 3, and Interactive Selection Menu 4. The Patch Interpreter 3 reads dynamic patch files and generates and processes sound(s), wherein such dynamic patch files are capable of being edited using Patch Editor 2. Control Elements 5, Local Display Unit 6, and Selection Actuator 7 interface with Interactive Selection Menu 4 through a serial data link to Interface Controller 8 (e.g. running on a microcontroller) from Interactive Selection Menu 4. The TEMS comprises one or more Control Elements 5 positioned for suitable access by a system operator and is designed to interface with the dynamic patches, wherein said control elements comprise at least one tactilated control element. Local Display Unit 6, allows for locally displaying information within the system. Selection Actuator 7 is operationally associated with Local Display Unit 6 for making selections in the interactive selection menu interface.

Operating System 1 is also able to convert digital audio bit stream to and from analog sound through Audio Hardware 9. Ports/Jacks/Adapters 10 also interface with Operating System 1 to afford the ability to send and/or receive data, for example via USB, HDMI, video, MIDI, and/or WiFi.

Lastly, optional Expansion Control Linkage 11, which interfaces with Operating System 1, affords the TEMS the ability to serially link with one or more expansion modules.

### Example 2

### Instructions Stored on the Hardware of the TEMS

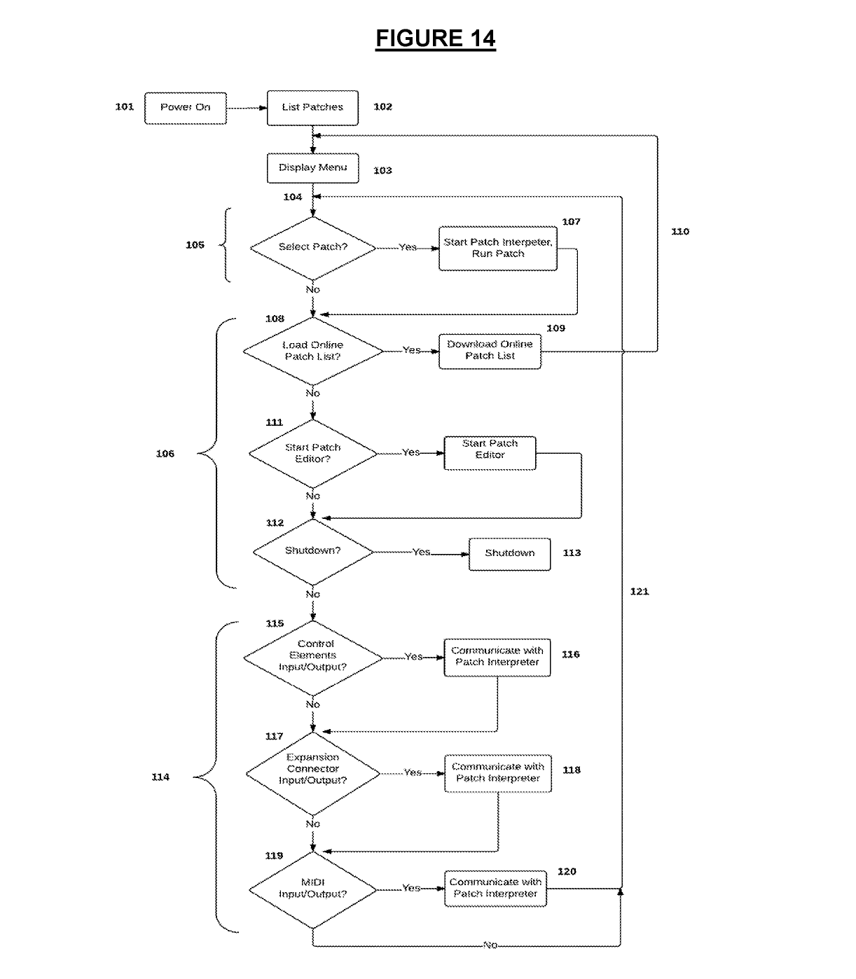

One embodiment of the instructions stored on the hardware of the TEMS of the present invention, is depicted in the flow chart of FIG. 14.

The TEMS of the present invention operates through instructions stored on the hardware of the TEMS. The flow chart of FIG. 14 depicts an example of the decision tree of these instructions and the associated methodology.

The TEMS is powered up and all the hardware is initialized in 101. The TEMS identifies a storage device, e.g., a USB storage device, and searches for patches in 102. It then creates a list of the patches found. The list of patches and system commands is displayed in a menu on the local display unit in 103.

The main data loop begins at 104 where the TEMS analyzes whether the user has selected a patch or a system command from the list in 105 using the selection actuator in 106, and then handles control element interfacing with the dynamic patches in 114.

If the user selected a new patch using the selection actuator, the patch interpreter program is started in 107. The patch interpreter loads the selected patch and begins running the selected patch (processing and/or generating sound).

In certain embodiments, the patch may be loaded from a drive or from an online server. As such, if the user selected a system command in 106 using the selection actuator, the TEMS checks if the user selected the system command to load patches from WiFi in 108; and if so, the TEMS connects to a an online server and loads a list of available patches 109. In 110 after retrieving the list of patches it returns to 103 to display the menu with the new list.

After the patch interpreter has begun running, the user may select to start the patch editor in 111 using the selection actuator, the TEMS starts the patch editor to allow for patch editing/creation/deletion. If the user selected to shut down the TEMS in 112 using the selection actuator, all process are stopped and the device is powered down 113.

After checking for user input from the selection actuator in 105 and 106, the TEMS then handles control interfacing in 114. First the TEMS checks for control element data input and output in 115. It communicates this control element data with the patch interpreter, allowing the running patch to interact with the control elements 116. Next the TEMS checks for control element data input and output from the expansion connector in 117. It communicates this control element data with the patch interpreter, allowing the running patch to interact with the control elements from the expansion connector 118.

The TEMS also may check for MIDI input or output 119. It communicates this MIDI data with the patch interpreter, allowing the running patch to interact with MIDI 120. In 121 the TEMS may then returns to 104, the start of the main data loop. The speed at which this data loop occurs allows for essentially continual access to the selections using the selection actuator and reception of input related to the control elements.

### Example 3

### Sample Tactilated Electronic Music System (TEMS)

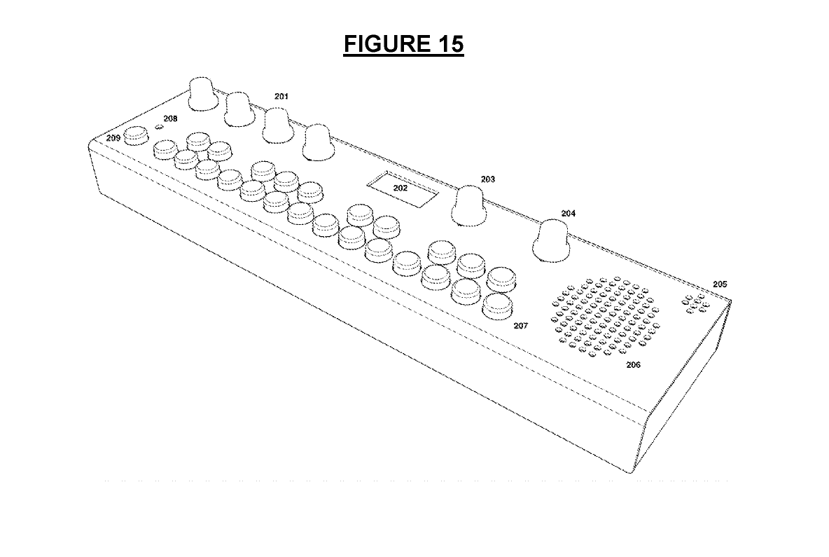

One embodiment of the TEMS of the present invention, is depicted in FIG. 15.

Control elements 201 comprise 4 knobs/potentiometers. Local display unit 202 may be used to display the interactive selection menu, operationally associated with the selection actuator 203. The volume control is shown at 204, a built-in microphone at 205, and a built in speaker at 206. Control elements 207 comprise force sensitive keys in a piano keyboard orientation. Control element 208 is an LED indicator. Control element 209 is a force-sensitive aux button.

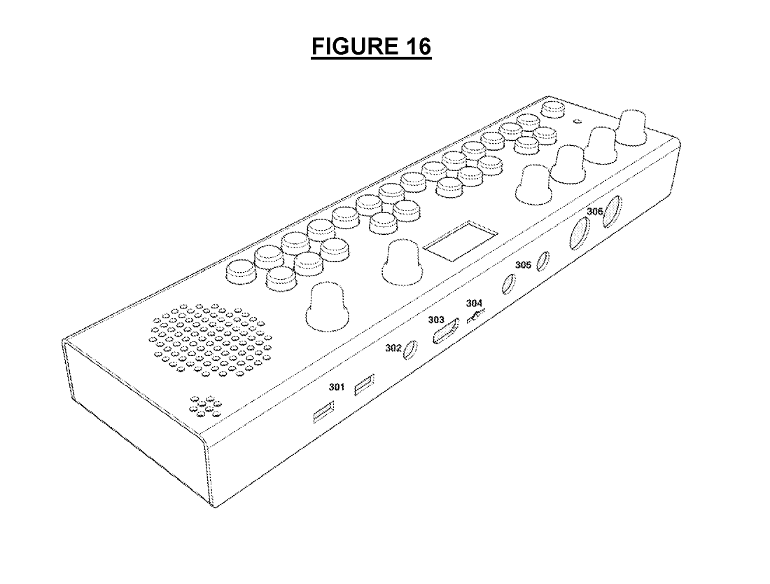

A rear perspective view of the TEMS is depicted in FIG. 16. Two USB ports 301 are shown, for example, for connecting a keyboard, a mouse, and/or a USB memory device(s). Power jack 302 is shown for receiving power to power the operations of the TEMS. Ports used for HDMI 303, micro SD memory card 304, and MIDI 306 are also shown. The audio input and output 305 are also shown.

### INCORPORATION BY REFERENCE

The entire contents of all patents, published patent applications and other references cited herein are hereby expressly incorporated herein in their entireties by reference.

### EQUIVALENTS

Those skilled in the art will recognize, or be able to ascertain using no more than routine experimentation, numerous equivalents to the specific procedures described herein. Such equivalents were considered to be within the scope of this invention and are covered by the following claims. Moreover, any numerical or alphabetical ranges provided herein are intended to include both the upper and lower value of those ranges. In addition, any listing or grouping is intended, at least in one embodiment, to represent a shorthand or convenient manner of listing independent embodiments; as such, each member of the list should be considered a separate embodiment.

What is claimed is:

1. A tactilated electronic music system (TEMS) for sound generation comprising
an integrated CPU capable of efficiently managing an operating system and an advanced operational control structure, wherein the control structure is suitable to generate sound derived from dynamic patches; to convert digital audio bit stream to and from analog sound; to communicate data between the control elements and the other components of the control structure; and to operate an interactive selection menu interface;
a local display unit for locally displaying information within the system, and suitable for interfacing with the dynamic patches and the interactive selection menu;
a selection actuator operationally associated with the local display unit for making selections in the interactive selection menu interface; and
one or more control elements positioned for suitable access by a system operator designed to interface with the dynamic patches, wherein said control elements comprise at least one tactilated control element.

2. The TEMS of claim 1, wherein the control structure is suitable to process and generate sound derived from dynamic patches.

3. The TEMS of claim 1, further comprising an audio codec operationally associated with the CPU that converts digital audio bit stream to and from analog sound.

4. The TEMS of claim 1 further comprising a first machine-readable medium having instructions stored thereon for execution by a processor to perform a method comprising the steps of: scanning the control elements, reading the positions of each control element, displaying pixels on the local display unit, and communicating with the CPU,
such that the machine-readable medium is capable of communicating data between the control elements and the other components of the control structure.

5. The TEMS of claim 4, wherein the first machine-readable medium is a microcontroller operationally associated with the CPU.

6. The TEMS of claim 1 further comprising a second machine-readable medium having instructions stored thereon for execution by a processor to perform a method comprising the steps of: interpreting patch files; generating a digital audio bit stream; directing the digital audio bit stream to and from the audio hardware; and providing a graphical user interface for creating, editing, copying, sharing, and deleting patch files.

7. The TEMS of claim 1 further comprising a third machine-readable medium having instructions stored thereon for execution by a processor to perform a method comprising the steps of: communicating with the first machine-readable medium, sending and receiving data to and from the control elements, packaging data suitable for display, providing the interactive selection menu interface capable of responding to user input from the selection actuator, and communicating values from control elements into the second machine-readable medium.

8. The TEMS of claim 7, wherein the third machine-readable medium is capable of interfacing with the operating system.

9. The TEMS of claim 1, wherein the tactilated control elements comprise elements selected from the group consisting of keys, knobs, rotary encoders, buttons, and pads.

10. The TEMS of claim 1, wherein the TEMS further comprises one or more ports selected from the group consisting of HMDI, USB, memory card, and MIDI.

11. The TEMS of claim 1, wherein the TEMS comprises one or more adapters selected from the group consisting of Wi-Fi and Bluetooth.

12. The TEMS of claim 1, wherein the TEMS further comprises one or more jacks selected from the group consisting of a sound output jack, a sound input jack, and a headphone jack.

13. The TEMS of claim 1 further comprising a speaker unit.

14. The TEMS of claim 1 further comprising a battery.

15. The TEMS of claim 1 further comprising an enclosure.

16. An expandable tactilated electronic music system (TEMS) for sound generation comprising
an integrated CPU capable of efficiently managing an operating system and an advanced operational control structure, wherein the control structure is suitable to create, process and generate sound derived from dynamic patches; to convert digital audio bit stream into analog sound; to communicate data between the control elements and the other components of the control structure; and to operate an interactive selection menu interface;
a local display unit for locally displaying information within the system, and suitable for interfacing with the dynamic patches and the interactive selection menu;
a selection actuator operationally associated with the local display unit for making selections in the interactive selection menu interface;
one or more control elements positioned for suitable access by a system operator designed to interface with the dynamic patches, wherein said control elements comprise at least one tactilated control element; and
an expansion control linkage.

17. The TEMS of claim 16 further comprising one or more expansion modules that add functionality to the TEMS.

18. The TEMS of claim 17, wherein the expansion modules are selected from the group consisting of a speaker, a control element, a battery, a charge collector, an accelerometer, a port, an adapter, microphone, and a combination thereof.

19. The TEMS of claim 17, wherein the expansion module comprises an expansion control linkage for serially linking with another expansion module.

20. A method of producing music using a tactilated electronic music system (TEMS) comprising the steps of:
obtaining a tactilated electronic music system (TEMS) of claim 1; and
operating said TEMS,
such that music is produced from the operation of the TEMS.
